(19) United States
(12) Patent Application Publication
(10) Pub. No.: US 2008/0183510 A1
(43) Pub. Date: Jul. 31, 2008

(54) SYSTEM AND METHOD FOR FINANCING OTHER POST EMPLOYMENT BENEFIT (OPEB) PLANS

(76) Inventors: Mark G. Pollock, Novelty, OH (US); Richard T. Heffern, Gates Mills, OH (US)

Correspondence Address: PORTER WRIGHT MORRIS & ARTHUR, LLP;INTELLECTUAL PROPERTY GROUP, 41 SOUTH HIGH STREET, 28TH FLOOR, COLUMBUS, OH, 43215, US

(21) Appl. No.: 12/104,153

(22) Filed: Apr. 16, 2008

Related U.S. Application Data
(63) Continuation of application No. 11/866,679, filed on Oct. 3, 2007.
(60) Provisional application No. 60/868,208, filed on Dec. 1, 2006.

(51) Int. Cl. G06Q 40/00

(52) U.S. Cl. 705/4

(57) ABSTRACT

A method of financing a post employment benefit plan includes obtaining funds to fund the benefit plan which creates a debt, obtaining life insurance policies for selected employees, and creating a plan trust. The life insurance policies are single-premium private placement variable universal life type life insurance policies and have collective death benefits. The life insurance policies are transferred to the plan trust after the life insurance policies have been purchased and subject to an obligation of the plan trust to make benefit payments contracted by the benefit plan and for the plan trust to endorse a net amount at risk of the insurance policies. The plan trust retains a cash surrender value of the insurance policies. The debt is paid utilizing the death benefits endorsed by the plan trust.

### CROSS-REFERENCE TO RELATED APPLICATIONS

This application is a continuation of U.S. patent Ser. No. 11/866,679 filed on Oct. 3, 2007 which claims the benefit of U.S. Provisional Patent Application No. 60/868,208 filed on Dec. 1, 2006, the disclosures of which are expressly incorporated herein in their entireties by reference.

### STATEMENT REGARDING FEDERALLY SPONSORED RESEARCH

Not Applicable

### REFERENCE TO MICROFICHE APPENDIX

Not Applicable

### FIELD OF THE INVENTION

The present invention generally relates to an improved system and method for financing other post employment benefit (OPEB) plans and, more particularly, to an improved system and method for repayment of debt incurred to fund such plans.

### BACKGROUND OF THE INVENTION

In 2004, the Government Accounting Standards Board (GASB) issued new accounting and financial reporting standards for non-pension post employment benefit plans, also referred to as other post employment benefits (OPEB) plans, provided to governmental and other public sector employees. OPEB plans typically include post-retirement medical, prescription drug, dental, vision, hearing, and/or Medicare Plan B or Part D premiums. OPEB plans can also include life insurance, long term care, and/or long term disability when provided separately from a pension plan.

These new GASB standards are defined in two new statements: Statement No. 43—Financial Reporting for Post-Employment Benefit Plans Other Than Pension Plans; and Statement No. 45—Accounting and Financial Reporting by Employers for Post-employment Benefits Other Than Pensions (GASB 43/45). These statements address how all state and local government entities such as state, city, and county governments, school districts, water authorities, state colleges, hospitals, etc. should account for their costs and obligations related to OPEB liabilities. Cities, counties, or school districts etc. that participate in a statewide plan should follow GASB on an individual basis. It is estimated that there are approximately 36,000 government entities affected by this change. Most governmental employers use a pay-as-you-go method and are only reflecting OPEB benefits being paid in the current year as the expense. It has been estimated that these agencies have unrecognized liabilities in excess of two trillion dollars. It is likely that these unfunded OPEB liabilities and obligations will adversely impact credit, strain operating budgets, and reveal that many employers may be unable to fulfill obligations.

A critical component of compliance with GASB 43/45 is the development of a “Substantive Plan” that reflects a permanent commitment by the employer to provide an OPEB plan for retirees of the employer. GASB Statement 43 defines a “Substantive Plan” as a plan through which assets are accumulated and benefits are paid as they come due in accordance with an agreement or understanding between the employer and plan members and their beneficiaries. The major components of a “Substantive Plan” include: written plan document; specific level of benefits; eligibility; communication between employer and plan members (record of and copies); historical practice patterns; funding plan and reporting standards; and amendments and updates as changes are made. Importantly, the OPEB liabilities must be recorded in the financial statements.

To date, there have been at least three methods used to address OPEB liabilities: unfunded plans on a pay-as-you-go basis; funded plans; and OPEB obligation bonds. Most plans are currently funded on a pay-as-you go basis. As best shown in FIG. 1, the government entity makes payments as they become due. The government entity must recognize the total unfunded actuarial accrued liability (UAAL) on its financial statement using a low discount rate, such as 2% to 4%, and each year unfunded actual required contributions (ARC) add to the unfunded liability. It is noted that GASB 43/45 require accrual accounting of costs; they do not require advance funding. Without a systematic method of pre-funding the post-employment costs, future cash outlays will dramatically increase in future years.

As best shown in FIG. 2, some employers set up an irrevocable trust that satisfies the requirements of GASB 43/45 or some other suitable trust and contribute annually to the trust both normal costs and UAAL amortization. The trust invests the funds in a professionally managed portfolio and makes payments under the plan to the retired employees, beneficiaries, and eligible dependents as they become due. The government entity must recognize the total UAAL on its financial statement but can use a higher discount rate, such as +/−8%. The higher discount rate can reduce liabilities by as much as 50%. Over time, liability is reduced since cash flow is higher. Many plan administrators elect annual funding arrangements equal to the ARC. The liability reflected on the balance sheet is the difference between what is paid and the ARC. While the UAAL is reflected in footnotes.

As best shown in FIG. 3, some employers set up an irrevocable OPEB trust that satisfies the requirements of GASB 43/45 or some other suitable trust and issue bonds in an amount equal to the OPEB UAAL. The government entity deposits the bond proceeds to the trust so that the UAAL is 100% funded and annually contributes normal costs. The trust invests the funds in a professionally managed portfolio and makes payments under the plan to the retired employees, beneficiaries, and eligible dependents as they become due. The government entity must make principal and interest payments on the bond debt. The arbitrage between interest paid on the bond and the investment return on the assets in the OPEB trust can help defray the long-term costs of the OPEB liabilities.

While the above-described methods used to address OPEB liabilities may meet the reporting requirements of GASB 43/45 and may fund the UAAL, the resulting debt service can strain of the operating budget of most if not all employers and some employers may not be able to fulfill the obligations. Accordingly, there is a need in the art for an improved system and method for financing other post employment benefit plans.

### SUMMARY OF THE INVENTION

The present invention provides an improved system and method for financing other post employment benefit (OPEB) plans which overcomes at least some of the above-noted problems of the related art. According to the present invention, method of financing a post employment benefit plan comprises the steps of, in combination, obtaining funds to fund the benefit plan which creates a debt, obtaining life insurance policies for selected employees, and creating a plan trust. The life insurance policies have collective death benefits. The life insurance policies are transferred to the plan trust after the life insurance policies have been purchased and subject to an obligation of the plan trust to make benefit payments contracted by the benefit plan and for the plan trust to endorse at least a portion of the death benefits of the insurance policies. The debt is paid utilizing the death benefits endorsed by the plan trust.

According to another aspect of the present invention, a method of financing a post employment benefit plan comprises the steps of, in combination, obtaining funds to fund the benefit plan which creates a debt, obtaining life insurance policies for selected employees, and creating a plan trust. The life insurance policies have collective death benefits. The life insurance policies are transferred to the plan trust after the life insurance policies have been purchased and subject to an obligation of the plan trust to make benefit payments contracted by the benefit plan and for the plan trust to endorse a net amount at risk of the insurance policies. The plan trust retains a cash surrender value of the insurance policies. The debt is paid utilizing the death benefits endorsed by the plan trust.

According to yet another aspect of the present invention, a method of financing a post employment benefit plan comprises the steps of, in combination, obtaining funds to fund the benefit plan which creates a debt, obtaining life insurance policies for selected employees, and creating a plan trust. The life insurance policies are single-premium private placement variable universal life type life insurance policies and have collective death benefits. The life insurance policies are transferred to the plan trust after the life insurance policies have been purchased and subject to an obligation of the plan trust to make benefit payments contracted by the benefit plan and for the plan trust to endorse a net amount at risk of the insurance policies. The plan trust retains a cash surrender value of the insurance policies. The debt is paid utilizing the death benefits endorsed by the plan trust.

From the foregoing disclosure and the following more detailed description of various preferred embodiments it will be apparent to those skilled in the art that the present invention provides a significant advance in improved system and method for financing other post employment benefit plans. Particularly significant in this regard is the potential the invention affords for repayment of debts incurred by funding such plans. Additional features and advantages of various preferred embodiments will be better understood in view of the detailed description provided below.

### BRIEF DESCRIPTION OF THE DRAWINGS

These and further features of the present invention will be apparent with reference to the following description and drawings, wherein:

FIG. 1 is a diagrammatic view of a prior art pay-as-you-go system for financing OPEB liabilities;

FIG. 2 is a diagrammatic view of a prior art system for financing OPEB liabilities which is funded through the payment of the annual required contribution;

FIG. 3 is a diagrammatic view of a prior art system for financing OPEB liabilities is funded through government issued bonds;

FIG. 4 is a diagrammatic view of a system for financing OPEB liabilities according to the present invention, wherein life insurance policies are purchased on key employees and death benefits from the policies are used to retire debt incurred by funding the plan;

FIG. 5 is diagrammatic view of a process according to the present invention for implementing the system of FIG. 4;

FIG. 6 is a diagrammatic view of a variation of the system of FIG. 4, wherein proceeds from the life insurance policies are paid to a securitization trust which uses proceeds to retire debt incurred by funding the plan;

FIG. 7 is a diagrammatic view of a variation of the system of FIG. 4, wherein the government entity purchases the life insurance policies and assigns ownership of the policies to the OPEB trust subject to endorsement of at least a portion of death benefits of the life insurance policies to the government entity to retire debt incurred by funding the plan;

FIG. 8 is a diagrammatic view of a variation of the system of FIG. 4, wherein the government entity purchases the life insurance policies and assigns ownership the policies to the OPEB trust subject to endorsement of at least a portion of death benefits of the life insurance policies to the government entity and the endorsed portion of the death benefits from the life insurance policies are paid to a counterparty which provides a guaranteed income to the government entity to retire the debt;

FIG. 9 is a diagrammatic view of a system for utilizing certificate of participation as the financing means; and

FIG. 10 is a diagrammatic view of a comparison of various types of life insurance.

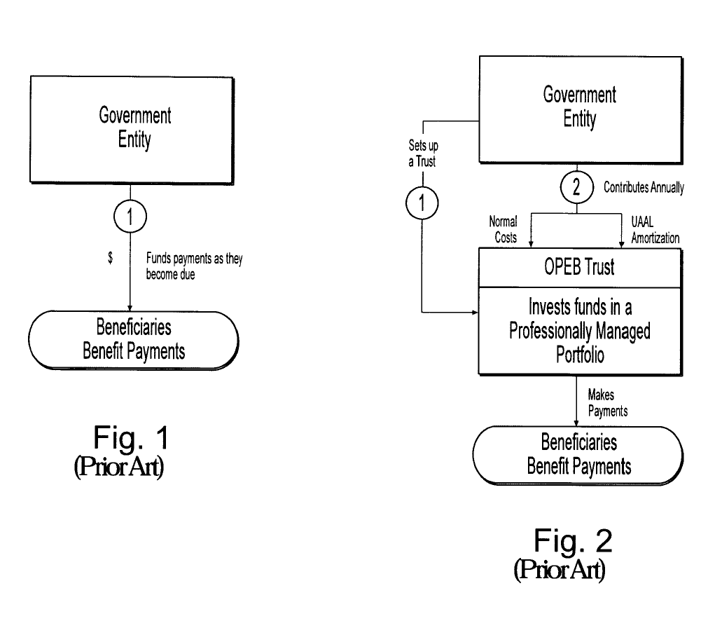

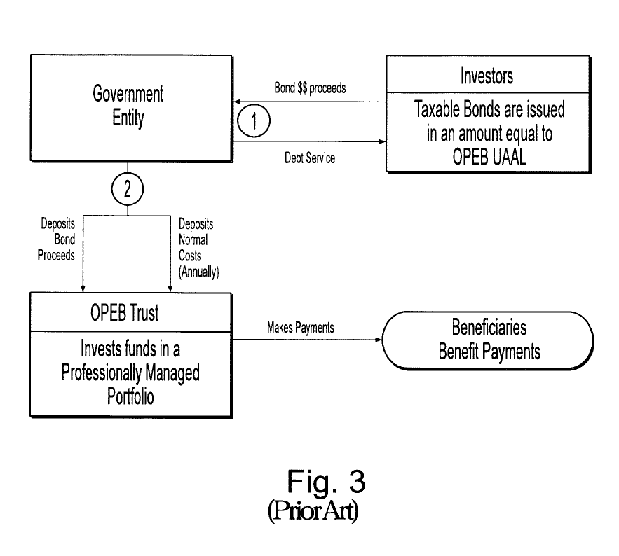

### DETAILED DESCRIPTION OF CERTAIN PREFERRED EMBODIMENTS

It will be apparent to those skilled in the art, that is, to those who have knowledge or experience in this area of technology, that many uses and design variations are possible for the improved system and method for financing other post employment benefit (OPEB) plans disclosed herein. The following detailed discussion of various alternative and preferred embodiments will illustrate the general principles of the invention with reference to an improved system and method utilizing bonds for financing OPEB liabilities of a government entity. Other embodiments suitable for other applications will be apparent to those skilled in the art given the benefit of this disclosure such as, for example, the financing means can be means other than bonds, the employer can be other than a government entity, and/or the liabilities can be other than OPEB liabilities.

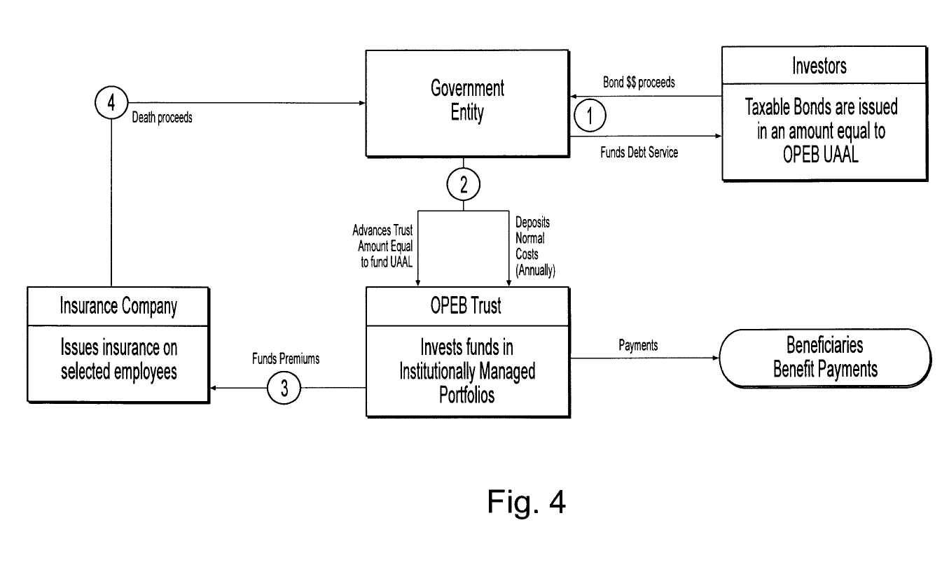

FIG. 4 illustrates a system and method for financing OPEB liabilities or the like according to the present invention. The government entity employer or other employer sets up a plan trust such as an irrevocable OPEB trust that satisfies the requirements of GASB 43/45 or any other suitable trust and issues bonds to fund at least a portion of the OPEB UAAL. Preferably, the bonds are issued in an amount at least equal to the OPEB UAAL to fully fund the OPEB UAAL. The government entity employer deposits the bond proceeds into the plan trust so that the UAAL is at least partially funded and preferably 100% funded. The government entity employer also annually contributes the normal costs into the plan trust. The plan trust invests the funds in a professionally managed portfolio and makes benefit payments to plan beneficiaries or plan members of the OPEB plan as they become due. The plan members typically include retired employees and their beneficiaries and dependents. The plan trust also purchases life insurance policies on selected employees of the government entity employer. It is noted that the term “employees” is used in this specification and claims to mean current employees, former employees having a vested interest in the plan, and retirees. The plan trust pays the premiums for the life insurance policy directly to the life insurance company. In the illustrated embodiment, the plan trust endorses at least a portion of the death benefits of the insurance policies to the government employer. The plan trust can endorse all the death benefits of the insurance policies to the employer but preferably utilizes a split dollar arrangement where a portion of the death benefits are retained by the plan trust and a portion of the death benefits are endorsed to the employer. A preferred split dollar arrangement enables the plan trust to retain the cash surrender value of the insurance policies at the date of death and endorse the net amount at risk of the insurance policies (that is, the total death benefit less the cash surrender value at death) to the employer. Preferably, the portion of the death benefits endorsed to the employer is capped at the amount of principle and interest due on the debt owed by the employer The employer uses the death benefits to make principal and interest payments on the debt when due. It should be appreciated that the death benefits of the purchased insurance policies can fully liquidate the debt.

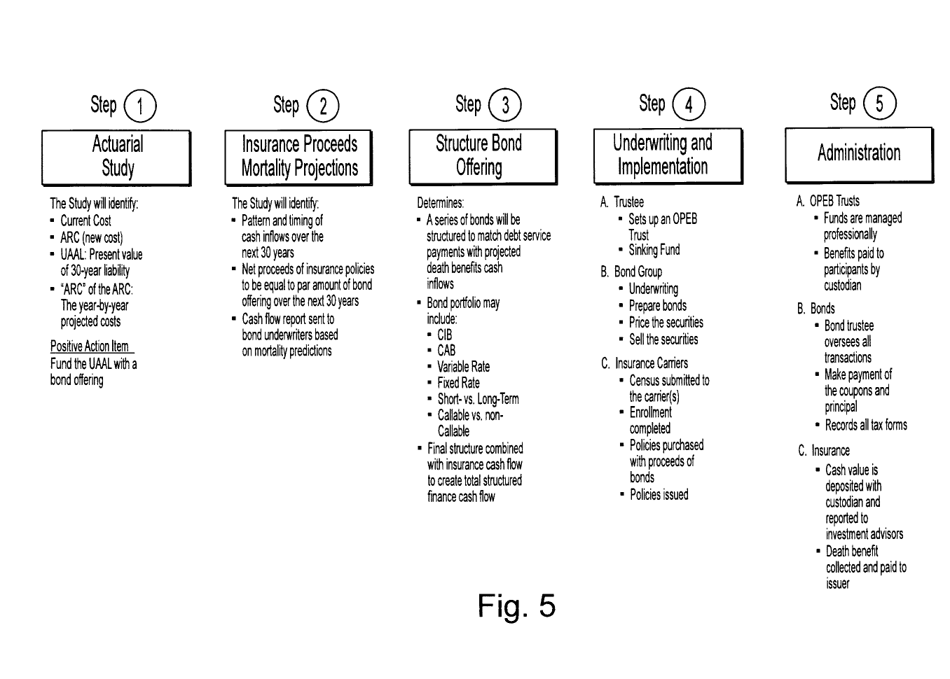

FIG. 5 illustrates a five-step process for selecting, implementing and administrating a system and method for financing OPEB liabilities or the like according to the present invention. The process includes the steps of actuarial study, insurance proceeds mortality projections, structure bond offering, underwriting implementation, and administration. The actuarial study identifies the current cost, the ARC (the new cost), the UAAL (present value of 30-year liability), and the “ARC” of the ARC which is a year-by-year projection of costs. The actuarial calculations are preferably performed in what is referred to as an actuarial valuation. This valuation depends on the total membership of the government entity employer including active employees, terminated employees with accumulated benefits but not yet receiving them, and retired employees and their beneficiaries and dependents currently receiving benefits. The actuarial valuation includes making certain assumptions and calculations related to the actuarial cost method, the plan assets, rates of return, and employee census data. Common actuarial assumptions review both demographic variables (deaths, terminations, disability, retirement, etc.) and economic variables (deaths, retirees, cost trends, coverage changes, compensation increases, and plan expenses). The resultant sum of all of the calculations correlate with the corresponding accounting entries returned for the financial statements. An actuarial report is issued which identifies to the employer resulting liabilities and annual costs.

The second step looks at the pool of employees and mortality projections relating thereto. A portion of the employees to be insured are identified to obtain a desired pattern and timing of death benefit cash inflow from the life insurance policies over the next thirty years. The timing and amounts of the death benefits needs to at least equal to the face amounts of the debt if the debt is to be fully liquidated by the death benefits. It is noted that the projected death benefits are more preferably larger than 100% of the face amount of the debt such as, for example, at least 200% of the face amount of the bond issuances and more preferably at least 300% of the face amount of the bond issuances in order to reduce the risk of the mortality projections. A schedule of projected death benefit cash inflow over the next thirty years is sent to the bond underwriters.

The third step structures the bond offering. A series of bonds are structured to match funds with the projected death benefit cash inflows. The bond portfolio can include any suitable capital appreciation bond, variable rate, fixed rate, short term, long term, callable and/or non-callable bonds. The final structure combined with insurance cash flow creates a total structured finance cash flow.

The fourth step underwrites and implements the system. A trustee sets up the plan trust and a sinking fund. A bond group underwrites the bonds, prepares the securities, prices the securities, and sells the securities. The census is submitted to insurance carriers whereby enrollment is completed and life insurance policies are issued. The life insurance can be structured in any desired manner such as, for example, keyman, endorsement split dollar, and equity split dollar.

The fifth step administrates the system. Within the plan trust, funds are professionally managed and benefits payments are paid to plan beneficiaries by a trust custodian as they become due. A bond trustee and/or registrar and paying agent oversees all transactions related to the bonds, makes payments of the coupons and the principal, and records all tax forms. As insured employees die, the cash value of the insurance policies are deposited with the plan trust custodian and reported to investment advisors and the net amount at risk of the insurance policies is collected by the government employer who pays the bond issuer.

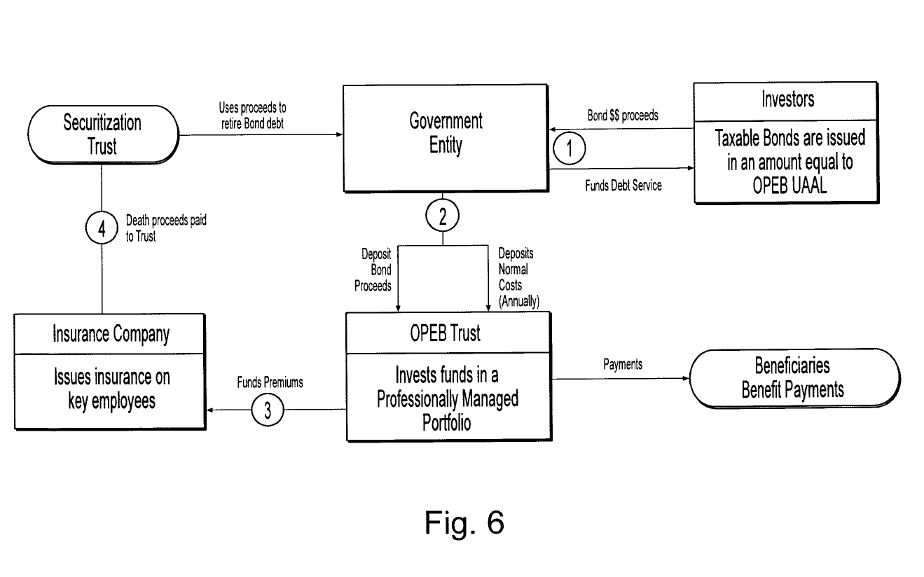

FIG. 6 illustrates a variation of the system and method for financing OPEB liabilities according to the present invention. The government entity employer or other employer sets up a plan trust such as an irrevocable OPEB trust that satisfies the requirements of GASB 43/45 or any other suitable trust and issues bonds in an amount to fund at least a portion of the OPEB UAAL. Preferably, the bonds are issued in an amount at least equal to the OPEB UAAL to fully fund the OPEB UAAL. The government entity employer deposits the bond proceeds into the plan trust so that the UAAL is at least partially funded and preferably 100% funded. The employer also annually contributes the normal costs into the plan trust. The plan trust invests the funds in a professionally managed portfolio and makes benefit payments to plan beneficiaries or plan members of the OPEB plan as they become due. The plan beneficiaries typically include retired employees and their beneficiaries and dependents. The plan trust also purchases life insurance policies on selected employees of the employer. It is noted that the term “employees” is used in this specification and claims to mean current employees, former employees having a vested interest in the plan, and retirees. The plan trust pays the premiums for the life insurance policy directly to the life insurance company. In the illustrated embodiment, the plan trust assigns at least a portion of the death benefits of the insurance policies to a securitization trust subject to an obligation to make payments to the employer for the debt. The plan trust can assign all the death benefits of the insurance policies to the securitization trust but preferably utilizes a split dollar arrangement where a portion of the death benefits are retained by the plan trust and a portion of the death benefits are assigned to the securitization trust. A preferred split dollar arrangement enables the plan trust to retain the cash surrender value of the insurance policies at the date of death and assign the net amount at risk of the insurance policies (that is, the total death benefit less the cash surrender value at death) to the securitization trust. Preferably, the portion of the death benefits assigned to the securitization trust is capped at the amount of principle and interest due on the debt owed by the employer As the insured employees die, the death proceeds of the life insurance policies are paid to the securitization trust. The securitization trust acts as a receptacle for holding and/or investing the death benefits of the insurance policies. The securitization trust then makes payments to the employer as payments for the debt become due. The employer uses the payments from the securitization trust to make principal and interest payments on the debt when due. It should be appreciated that the death benefits of the purchased insurance can fully liquidate the debt.

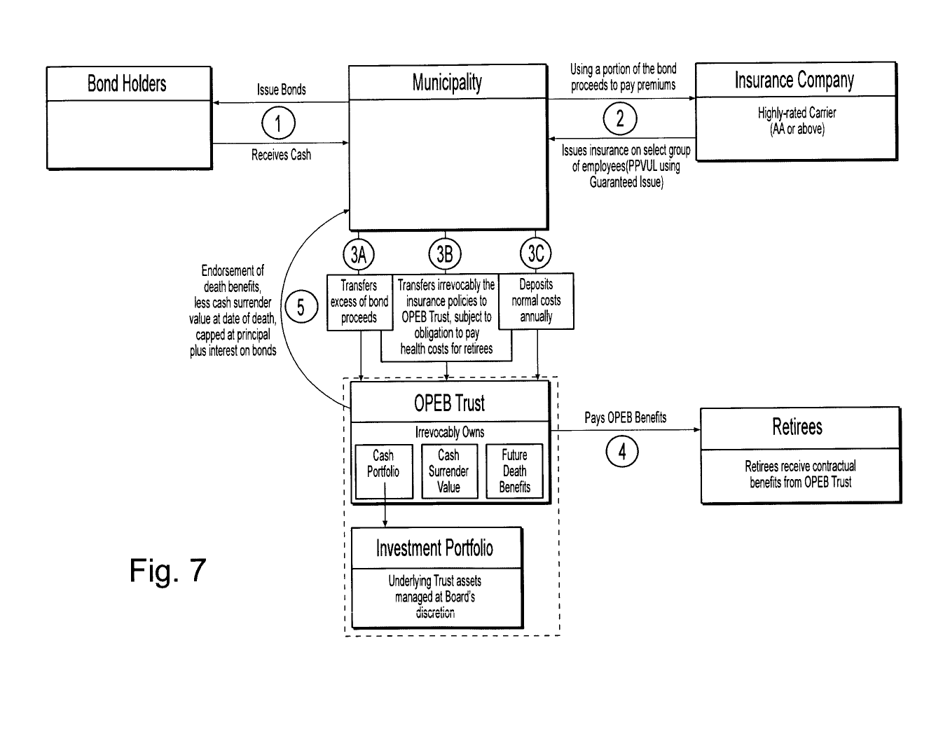

FIG. 7 illustrates another variation of the system and method for financing OPEB liabilities according to the present invention. The government entity or other employer sets up a plan trust such as an irrevocable OPEB trust that satisfies the requirements of GASB 43/45 or any other suitable trust and issues bonds in an amount to fund at least a portion of the OPEB UAAL. Preferably, the bonds are issued in an amount at least equal to the OPEB UAAL to fully fund the OPEB UAAL. The employer deposits the bond proceeds into the plan trust so that the UAAL is at least partially funded and preferably 100% funded. The employer also annually contributes the normal costs into the plan trust. The plan trust invests the funds in a professionally managed portfolio and makes benefit payments to beneficiaries of the OPEB plan as they become due. In this variation, however, the government entity employer or other employer purchases life insurance policies on selected employees of the employer. It is noted that the term “employees” is used in this specification and claims to mean current employees, former employees having a vested interest in the plan, and retirees. The employer pays the premiums for the life insurance policies directly to the life insurance company. Preferably, the insurance policies are single premium type policies so that no further premium payments are due after the life insurance policies are initially purchased. The employer then assigns or transfers the insurance policies to the plan trust subject to an obligation of the plan trust to pay benefit payments to the plan beneficiaries as they become due and endorsement by the plan trust of at least a portion of the death benefits of the insurance policies to the employer. Preferably, the plan trust endorses the death benefits of the insurance policies, less cash surrender value at date of death, which are preferably capped at the amount of principle and interest due on the debt to the employer. The plan trust thus keeps the cash surrender value of the policies and any death benefits that are above and beyond the total principle and interest due on the debt. As the insured employees die, the death benefits of the life insurance policies are paid directly to the plan trust which endorses all or a portion of them to the employer per the assignment agreement. The employer uses the death benefits to make principal and interest payments on the debt when due. It should be appreciated that the death benefits of the purchased insurance can fully liquidate the debt.

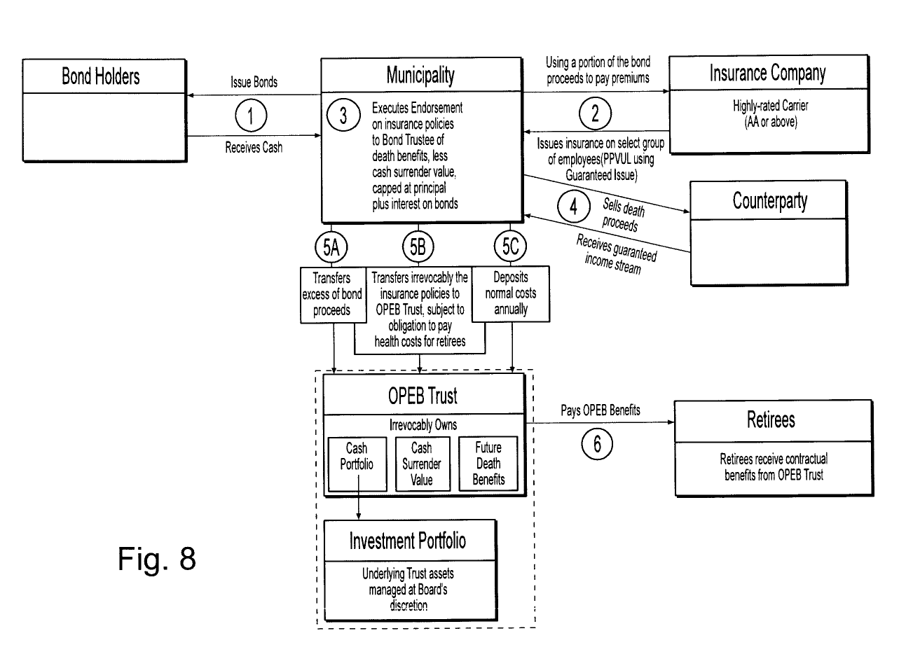

FIG. 8 illustrates yet another variation of the system and method for financing OPEB liabilities according to the present invention. The government entity or other employer sets up a plan trust such as an irrevocable OPEB trust that satisfies the requirements of GASB 43/45 or any other suitable trust and issues bonds in an amount to fund at least a portion of the OPEB UAAL. Preferably, the bonds are issued in an amount at least equal to the OPEB UAAL to fully fund the OPEB UAAL. The employer deposits the bond proceeds into the plan trust so that the UAAL is at least partially funded and preferably 100% funded. The employer also annually contributes the normal costs into the plan trust. The plan trust invests the funds in a professionally managed portfolio and makes benefit payments to beneficiaries of the OPEB plan as they become due. In this variation, however, the government entity employer or other employer purchases life insurance policies on selected employees of the employer. It is noted that the term “employees” is used in this specification and claims to mean current employees, former employees having a vested interest in the plan, and retirees. The employer pays the premiums for the life insurance policies directly to the life insurance company. Preferably, the insurance policies are single premium type policies so that no further premium payments are due after the life insurance policies are initially purchased. The employer then assigns or transfers the insurance policies to the plan trust subject to an obligation of the plan trust to pay benefit payments to the plan beneficiaries as they become due and endorsement by the plan trust of at least a portion of the death benefits of the insurance policies to the employer. Preferably, the plan trust endorses the death benefits of the insurance policies, less cash surrender value at date of death, which are preferably capped at the amount of principle and interest due on the debt to the employer. The plan trust thus keeps the cash surrender value of the policies and any death benefits that are above and beyond the total principle and interest due on the debt. The employer sells its portion of the death benefits of the insurance policies to a counterparty which provides guaranteed income, preferably in the form of fixed regular payments, to the employer. The employer is thus utilizing a mortality swap, that is, a swap of death benefits with associated mortality risk (non-fixed and non-guaranteed payments) for fixed guaranteed payments. The counterparty can be a financial institution, trust, or any other suitable third party. The employer uses the guaranteed income from the counterparty to make principal and interest payments on the bond debt when due. As the insured employees die, the death benefits of the life insurance policies are paid directly to the plan trust which endorses them to the employer per the assignment agreement and the employer endorses them to the counterparty per the sale agreement. It should be appreciated that the death benefits of the purchased insurance (and guaranteed payments) can fully liquidate the debt.

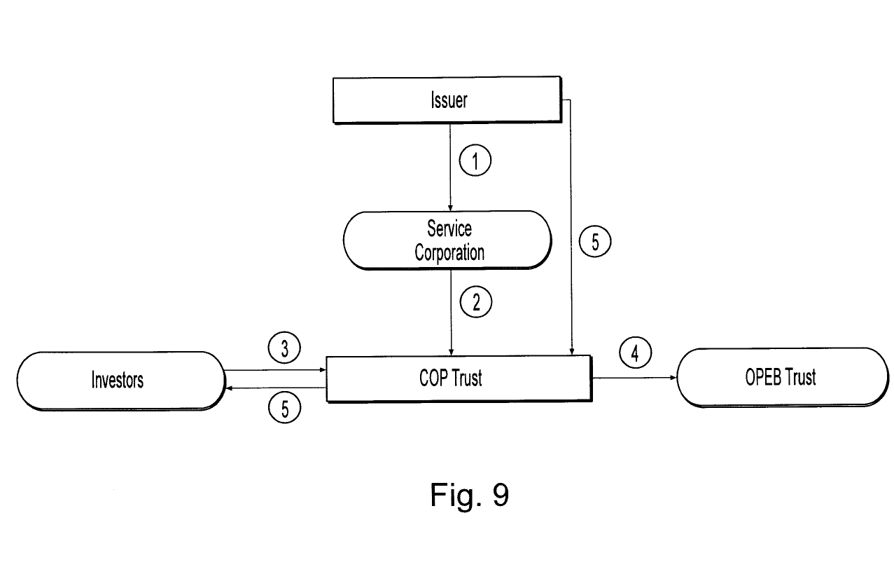

It is noted that the repayment aspect of the present invention can be utilized with bonds or any other suitable source of funds. For example, the financing method can be certificates of participation rather than bonds. FIG. 9 illustrates how certificates of participation can be utilized in conjunction with the present invention. An insurer enters into a binding service contract with a non-profit service corporation (a joint powers or authorized entity) for the sole purpose of providing funds to make periodic COP service payments in return for an agreement to perform services in the current year and in future years of reducing the financial burden (UAAL). The service corporation forms a funding trust (COP trust) on the closing date and irrevocably assigns to the COP trust all rights to receive, collect and enforce all COP service payments due under the service contract. The COP trust issues and sells COPs to investors. The COP trust irrevocably deposits the COP proceeds to the OPEB trust. The OPEB trust is not a party to the service contracts or the COP trust. The Issuer makes required contractual payments to the COP trust as outlined above. The COP trust pays principle and interest to the investors.

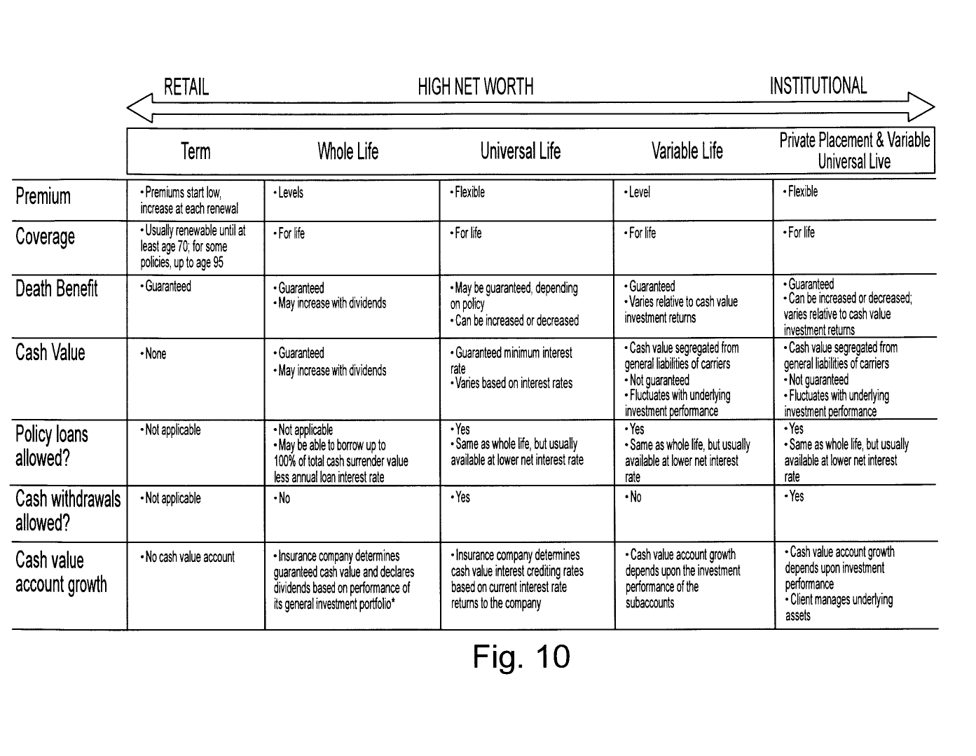

FIG. 10 illustrates a comparison of various types of life insurance which can be utilized by the present invention including term, whole life, universal, variable life, and private placement variable universal life. As best shown in FIG. 8, a single-premium private placement variable universal life type life insurance is preferably utilized. This type of life insurance allows for the creation of a wrapper of insurance with full choice of funds to mirror the plan benefits. Also, a single payment of one premium makes it easier for the employer to purchase the policy and transfer the policy to the plan trust. Also, there are no concerns about premium payments if the policies have a rider for a securitization trust.

It is noted that the features of the various disclosed embodiments can be utilized with the other embodiments if desired. For example, the securitization trust of the embodiment of FIG. 6 can be utilized with the embodiment of FIG. 7 or the mortality swap of the embodiment of FIG. 8 can be utilized with the embodiment of FIG. 4.

From the foregoing disclosure and detailed description of certain preferred embodiments, it is apparent that the system and method according to the present invention provides plan sponsors with the ability of fully funding a financial burden in actuarial determined benefit program (OPEB, pension, or other) by using the lowest blended cost of capital including the ability of recovering at least a portion of the funded costs. Other advantages include diversification of risk and credit enhancement through a series of capital market transactions.

From the foregoing disclosure and detailed description of certain preferred embodiments, it is also apparent that various modifications, additions and other alternative embodiments are possible without departing from the true scope and spirit of the present invention. The embodiments discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention as determined by the appended claims when interpreted in accordance with the benefit to which they are fairly, legally, and equitably entitled.

What is claimed is:

1. A method for financing an other post employment benefit plan, said method comprising the steps of, in combination:
obtaining funds to fund the benefit plan which creates a debt;
obtaining life insurance policies for selected employees;
wherein the life insurance policies have collective death benefits;
creating a plan trust;
transferring the life insurance policies to the plan trust after the life insurance policies have been purchased and subject to an obligation of the plan trust to make benefit payments contracted by the benefit plan to plan members and for the plan trust to endorse back to the transferor at least a portion of the death benefits of the insurance policies; and
paying the debt utilizing the death benefits endorsed by the plan trust.

2. A method for financing an other post employment benefit plan, said method comprising the steps of, in combination:
obtaining funds to fund the benefit plan which creates a debt;
obtaining life insurance policies for selected employees;
wherein the life insurance policies have collective death benefits;
creating a plan trust;
transferring the life insurance policies to the plan trust after the life insurance policies have been purchased and subject to an obligation of the plan trust to make benefit payments contracted by the benefit plan to plan members and for the plan trust to endorse back to the transferor a net amount at risk of the insurance policies;
wherein the plan trust retains a cash surrender value of the insurance policies; and
paying the debt utilizing the death benefits endorsed by the plan trust.

3. A method for financing an other post employment benefit plan, said method comprising the steps of, in combination:
obtaining funds to fund the benefit plan which creates a debt;
obtaining life insurance policies for selected employees;
wherein the life insurance policies are single-premium private placement variable universal life type life insurance policies;
wherein the life insurance policies have collective death benefits;
creating a plan trust;
transferring the life insurance policies to the plan trust after the life insurance policies have been purchased and subject to an obligation of the plan trust to make benefit payments contracted by the benefit plan to plan members and for the plan trust to endorse back to the transferor a net amount at risk of the insurance policies;
wherein the plan trust retains a cash surrender value of the insurance policies; and
paying the debt utilizing the death benefits endorsed by the plan trust.
